(19) United States
(12) Patent Application Publication
(10) Pub. No.: US 2023/0045011 A1
(43) Pub. Date: Feb. 9, 2023

(54) COMMUNICATION SYSTEM BASED ON NEURAL NETWORK MODEL, AND CONFIGURATION METHOD THEREFOR

(71) Applicant: NTT DOCOMO, INC., Tokyo (JP)

(72) Inventors: Xufei Zheng, Beijing (CN); Anxin Li, Beijing (CN); Xuhong Guo, Beijing (CN); Yu Jiang, Beijing (CN); Lan Chen, Beijing (CN)

(73) Assignee: NTT DOCOMO, INC., Tokyo (JP)

(21) Appl. No.: 17/759,168

(22) PCT Filed: Nov. 10, 2020
(86) PCT No.: PCT/CN2020/127846

§ 371 Date: Jul. 20, 2022

(30) Foreign Application Priority Data
Jan. 21, 2020 (CN) 202010072490.1

(51) Int. Cl. H04L 41/0813; G06N 3/04; G06N 3/08

(52) U.S. Cl. CPC H04L 41/0813; G06N 3/04; G06N 3/08

(57) ABSTRACT

The present disclosure relates to a communication system based on a neural network model, and a configuration method therefor. The communication system includes at least one master node and multiple child nodes that are in communication connection with the master node, and a child node neural network model is configured in each of the multiple child nodes. The configuration method for the communication system includes: obtaining feature information of the multiple child nodes; and dynamically configuring the child node neural network models on the basis of the obtained feature information.

### TECHNICAL FIELD

The present disclosure relates to the field of mobile communication technology and artificial intelligence (AI), and more particularly, the present disclosure relates to a communication system based on neural network model and configuration method therefor.

### BACKGROUND

In the traditional mobile communication system, the network deployment, operation and maintenance are mainly completed by manual means, which not only consumes a lot of human resources but also increases the operating cost, and the network optimization is not ideal. With the commercial application of the fifth generation mobile communication technology, the communication system is developing in the direction of network diversification, broadbandization, integration and intelligence, thus complex tasks such as network optimization, large-scale input data set processing, network recommendation or network element configuration are becoming greater challenges. At the same time, due to the breakthrough of big data technology, computing power, and various algorithms and network frameworks in recent years, the artificial intelligence technology has also shown a explosive growth. At present, the artificial intelligence technology is increasingly combined with the mobile communication technology. The mobile communication technology provides the artificial intelligence technology with big data throughput and low delay transmission required by many intelligent application scenarios, while the artificial intelligence technology also provides powerful solutions to various complex problems in the mobile communication technology.

In a communication system composed of at least one master node and a plurality of child nodes communicatively connected with the master node, neural network models are configured in the master node and the child nodes to perform complex tasks such as network optimization, large-scale input data set processing, network recommendation or network element configuration. When a new child node is added to the communication system, it is necessary to initialize the neural network model of the newly added child node. If only the predetermined default settings are adopted, the targeted optimal configuration cannot be realized. At the same time, in the operating process of the communication system, if the configured neural network model is not updated for specific tasks, it will be difficult to achieve the best processing effect. Furthermore, in the training process for a specific task, if only the local data of a single child node is used for training, the best model optimization and model sharing between the same or similar child nodes cannot be realized due to the limited training data. In addition, only using the latest data to perform training can't use the historical training data to improve the accuracy of neural network model processing.

### SUMMARY

The present disclosure has been made in view of the above problems. The invention discloses a communication system based on a neural network model and a configuration method therefor.

According to an aspect of the present disclosure, there is provided a communication system configuration method based on neural network model, the communication system comprises at least one master node and a plurality of child nodes communicatively connected with the master node, and a child node neural network model is configured in each of the plurality of child nodes, and the communication system configuration method includes: acquiring characteristic information of the plurality of child nodes; and dynamically configuring the child node neural network model based on the acquired characteristic information.

Furthermore, the communication system configuration method according to an aspect of the present disclosure, wherein the acquiring characteristic information of the plurality of child nodes comprises: receiving the characteristic information transmitted from one child node of the plurality of child nodes.

Furthermore, the communication system configuration method according to an aspect of the present disclosure, wherein the acquiring characteristic information of the plurality of child nodes comprises: receiving initial information transmitted from one child node of the plurality of child nodes; and predicting the characteristic information of the one child node based on the initial information.

Furthermore, the communication system configuration method according to an aspect of the present disclosure, wherein the dynamically configuring the child node neural network model based on the acquired characteristic information comprises: selecting one neural network model from a plurality of predetermined neural network models based on the characteristic information; and configuring the child node neural network model of the one child node by using the selected one neural network model.

Furthermore, the communication system configuration method according to an aspect of the present disclosure, wherein the dynamically configuring the child node neural network model based on the acquired characteristic information comprises: selecting a matching child node that matches the one child node from the plurality of child nodes based on the characteristic information; receiving a child node neural network model of the matching child node from the matching child node; and configuring the child node neural network model of the one child node by using the child node neural network model of the matching child node.

Furthermore, the communication system configuration method according to an aspect of the present disclosure, wherein the one child node is a child node newly added to the communication system.

Furthermore, the communication system configuration method according to an aspect of the present disclosure, wherein the acquiring characteristic information of the plurality of child nodes comprises: receiving the characteristic information transmitted from each of the plurality of child nodes.

Furthermore, the communication system configuration method according to an aspect of the present disclosure, wherein the dynamically configuring the child node neural network model based on the acquired characteristic information comprises: classifying the plurality of child nodes into a plurality of categories based on the characteristic information; using the characteristic information, training the child node neural network model for the plurality of categories to obtain an updated child node neural network model; and updating the child node neural network models of the plurality of child nodes by using the child node neural network model.

Furthermore, the communication system configuration method according to an aspect of the present disclosure, wherein the dynamically configuring the child node neural network model based on the acquired characteristic information comprises: classifying the plurality of child nodes into a plurality of categories based on the characteristic information; notifying the characteristic information of the child nodes belonging to a same category among the plurality of categories to the child nodes of the same category according to the plurality of categories; and training the child nodes of the same category by using the characteristic information of the child nodes of the same category, and updating the child node neural network model of the child nodes of the same category.

Furthermore, the communication system configuration method according to an aspect of the present disclosure, wherein the characteristic information comprises: height of the child node, antenna configuration, coverage area size, service type, traffic volume, user distribution, environmental information, and historical configuration information.

Furthermore, the communication system configuration method according to an aspect of the present disclosure, wherein the configuring the child node neural network model comprises one of the following: establishing indexes of a plurality of neural network models, and using the indexes to indicate that the child node neural network model is one of the plurality of neural network models; indicating the child node neural network model by using a model weight of the neural network model; indicating the child node neural network model by using a model weight variation of the neural network model; and indicating the child node neural network model by using a semantic representation of the neural network model.

Furthermore, the communication system configuration method according to an aspect of the present disclosure, wherein the characteristic information is a historical optimal beam set of a user equipment corresponding to the child node, and wherein the historical optimal beam set comprises a difference sequence of a plurality of optimal beams at a plurality of consecutive time points and an optimal beam at a latest time point; or a difference sequence between the optimal beams of two adjacent time points in a plurality of consecutive time points;

Furthermore, the communication system configuration method according to an aspect of the present disclosure, wherein updating the child node neural network model by using the characteristic information comprises: determining a weight of each historical optimal beam by using the occurrence times of each historical optimal beam in the historical optimal beam set; and according to the weight of each historical optimal beam and the historical optimal beam set, constructing a weighted loss function to perform training to update the child node neural network model.

Furthermore, the communication system configuration method according to an aspect of the present disclosure, wherein updating the child node neural network model by using the characteristic information comprises: configuring an attention layer in the child node neural network model, and performing training with the child node neural network model including the attention layer to update the child node neural network model.

According to another aspect of the present disclosure, there is provided a communication system based on a neural network model, comprising at least one master node; a plurality of child nodes communicatively connected with the master node, and a child node neural network model is configured in each of the plurality of child nodes, wherein the at least one master node acquires characteristic information of the plurality of child nodes; and dynamically configures the child node neural network model based on the acquired characteristic information.

Furthermore, the communication system according to another aspect of the present disclosure, wherein the at least one master node receives the characteristic information transmitted from one child node of the plurality of child nodes.

Furthermore, the communication system according to another aspect of the present disclosure, wherein the at least one master node receives initial information transmitted from one child node of the plurality of child nodes; and predicting the characteristic information of the one child node based on the initial information.

Furthermore, the communication system according to another aspect of the present disclosure, wherein the at least one master node selects one neural network model from a plurality of predetermined neural network models based on the characteristic information; and configures the child node neural network model of the one child node by using the selected one neural network model.

Furthermore, the communication system according to another aspect of the present disclosure, wherein the at least one master node selects a matching child node that matches the one child node from the plurality of child nodes based on the characteristic information; receives a child node neural network model of the matching child node from the matching child node; and configures the child node neural network model of the one child node by using the child node neural network model of the matching child node.

Furthermore, the communication system according to another aspect of the present disclosure, wherein the one child node is a child node newly added to the communication system.

Furthermore, the communication system according to another aspect of the present disclosure, wherein the at least one master node receives the characteristic information transmitted from each of the plurality of child nodes.

Furthermore, the communication system according to another aspect of the present disclosure, wherein the at least one master node classifies the plurality of child nodes into a plurality of categories based on the characteristic information; using the characteristic information, trains the child node neural network model for the plurality of categories to obtain an updated child node neural network model; and updates the child node neural network models of the plurality of child nodes by using the child node neural network models.

Furthermore, the communication system according to another aspect of the present disclosure, wherein the at least one master node classifies the plurality of child nodes into a plurality of categories based on the characteristic information; notifies the characteristic information of the child nodes belonging to a same category among the plurality of categories to the child nodes of the same category according to the plurality of categories; and trains the child nodes of the same category by using the characteristic information of the child nodes of the same category, and updates the child node neural network model of the child nodes of the same category.

Furthermore, the communication system according to another aspect of the present disclosure, wherein the characteristic information comprises: height of the child node, antenna configuration, coverage area size, service type, traffic volume, user distribution, environmental information, and historical configuration information. Furthermore, the communication system according to another aspect of the present disclosure, wherein the configuring the child node neural network model comprises one of the following: establishing indexes of a plurality of neural network models, and using the indexes to indicate that the child node neural network model is one of the plurality of neural network models; indicating the child node neural network model by using a model weight of the neural network model; indicating the child node neural network model by using a model weight variation of the neural network model; and indicating the child node neural network model by using a semantic representation of the neural network model.

Furthermore, the communication system according to another aspect of the present disclosure, wherein the characteristic information is a historical optimal beam set of a user equipment corresponding to the child node, and wherein the historical optimal beam set comprises a difference sequence of a plurality of optimal beams at a plurality of consecutive time points and an optimal beam at a latest time point; or a difference sequence between the optimal beams of two adjacent time points in a plurality of consecutive time points;

Furthermore, the communication system according to another aspect of the present disclosure, wherein the at least one master node or the child node determines a weight of each historical optimal beam by using the occurrence times of each historical optimal beam in the historical optimal beam set; and according to the weight of each historical optimal beam and the historical optimal beam set, constructs a weighted loss function to perform training to update the child node neural network model.

Furthermore, the communication system according to another aspect of the present disclosure, wherein the at least one master node or the child node configures an attention layer in the child node neural network model, and performs training with the child node neural network model including the attention layer to update the child node neural network model.

As will be described in detail below, according to the communication system based on neural network model and configuration method therefor of the present disclosure, the dynamic configuration of neural network model for new child nodes in the communication system is realized, and online data is fully utilized in the operating process, and a centralized update at the master node by the master node or a distributed update at each child node is realized. In the process of dynamic configuration and update, the full sharing and utilization of training data and neural network model between the same or similar child nodes is considered, which improves the training efficiency and the accuracy of the obtained model. In addition, in the configuration process of the neural network model, various characteristics of child nodes, such as the height of child nodes, antenna configuration, coverage area size, service type, traffic volume, user distribution, environmental information and historical configuration information, are fully considered, and neural network model is represented by different ways, such as neural network model index, model weight of neural network model, model weight variation of neural network model and semantic representation of neural network model, which further improves the training efficiency and the accuracy of the obtained model. Furthermore, when carrying out the neural network model for specific tasks such as configuring the optimal beam candidate set for the user equipment, by adopting a lightweight recurrent neural network (RNN) and capturing the long-term dependence information of the input sequence by using a gated recurrent unit (GRU) module, selecting an appropriate training data representation and pertinently improving the construction of the loss function, meanwhile introducing the attention mechanism into the neural network mode to effectively extract valuable information from the input sequence, thus the accuracy of the optimal beam candidate set prediction is effectively improved, especially in the case of long-term prediction.

It is to be understood that both the foregoing general description and the following detailed description are exemplary and are intended to provide further explanation of the claimed technology.

### BRIEF DESCRIPTION OF THE DRAWINGS

The above and other objects, features and advantages of the present disclosure will become more apparent by describing the embodiments of the present disclosure in more detail with reference to the accompanying drawings. The accompanying drawings are used to provide a further understanding of the embodiments of the present disclosure, and form a part of the specification. Together with the embodiments of the present disclosure, they serve to explain the present disclosure, and do not constitute a limitation on the present disclosure. In the drawings, the same reference numerals generally represent the same parts or steps.

FIG. 1 is a schematic diagram outlining a communication system according to an embodiment of the present disclosure;

FIG. 2 is a flowchart outlining a communication system configuration method according to an embodiment of the present disclosure;

FIG. 3 is a schematic diagram illustrating one configuration example of a communication system according to an embodiment of the present disclosure;

FIG. 4 is a flowchart illustrating an example of a communication system configuration method according to an embodiment of the present disclosure;

FIG. 5 is a flowchart illustrating an example of a communication system configuration method according to an embodiment of the present disclosure;

FIG. 6 is a schematic diagram illustrating one configuration example of a communication system according to an embodiment of the present disclosure;

FIG. 7 is a flowchart illustrating an example of a communication system configuration method according to an embodiment of the present disclosure;

FIG. 8 is a flowchart illustrating an example of a communication system configuration method according to an embodiment of the present disclosure;

FIG. 9 is a schematic diagram illustrating one configuration example of a communication system according to an embodiment of the present disclosure;

FIG. 10 is a flowchart illustrating an example of a communication system configuration method according to an embodiment of the present disclosure;

FIG. 11 is a flowchart illustrating an example of a communication system configuration method according to an embodiment of the present disclosure;

FIG. 12 is a schematic diagram illustrating that the communication system according to the embodiment of the present disclosure performs an optimal beam scanning task;

FIG. 13 is a schematic diagram illustrating a training and prediction process of a neural network model configured in a communication system according to an embodiment of the present disclosure;

FIG. 14 is a schematic diagram illustrating a neural network model configured in a communication system according to an embodiment of the present disclosure; and

FIG. 15 is a block diagram illustrating an example of hardware configuration of a child node and a user equipment according to an embodiment of the present invention.

### DETAILED DESCRIPTION OF THE EMBODIMENTS

In order to make the objects, technical solutions and advantages of the present disclosure more obvious, exemplary embodiments according to the present disclosure will be described in detail below with reference to the accompanying drawings. Obviously, the described embodiments are only part of the embodiments of this disclosure, not all of them. It should be understood that this disclosure is not limited by the example embodiments described here.

The scheme provided by this disclosure relates to the combination of mobile communication technology and artificial intelligence technology, which is specifically illustrated by the following embodiments.

FIG. 1 is a schematic diagram outlining a communication system according to an embodiment of the present disclosure.

As shown in FIG. 1, a communication system 1 according to an embodiment of the present disclosure includes at least one master node 10 and a plurality of child nodes 11, 12, 13 and 14 communicatively connected with the master node. As the central control unit, the master node 10 implements the configuration, scheduling and management of the plurality of child nodes 11, 12, 13 and 14 and corresponding resources therefor. Child node neural network models 111, 121, 131 and 141 are configured in each of the plurality of child nodes 11, 12, 13 and 14.

In one embodiment of the present disclosure, the master node 10 is, for example, the central unit (CU) of the communication network, and the child nodes 11, 12, 13 and 14 are, for example, the distribution units (DUs) of the communication network. In another embodiment of the present disclosure, the master node 10 is, for example, a cloud server, and the child nodes 11, 12, 13 and 14 are, for example, multi-access edge computing (MEC) servers. It is easy to understand that the number and types of master nodes and child nodes, and the number and types of neural networks of child nodes are all non-limiting.

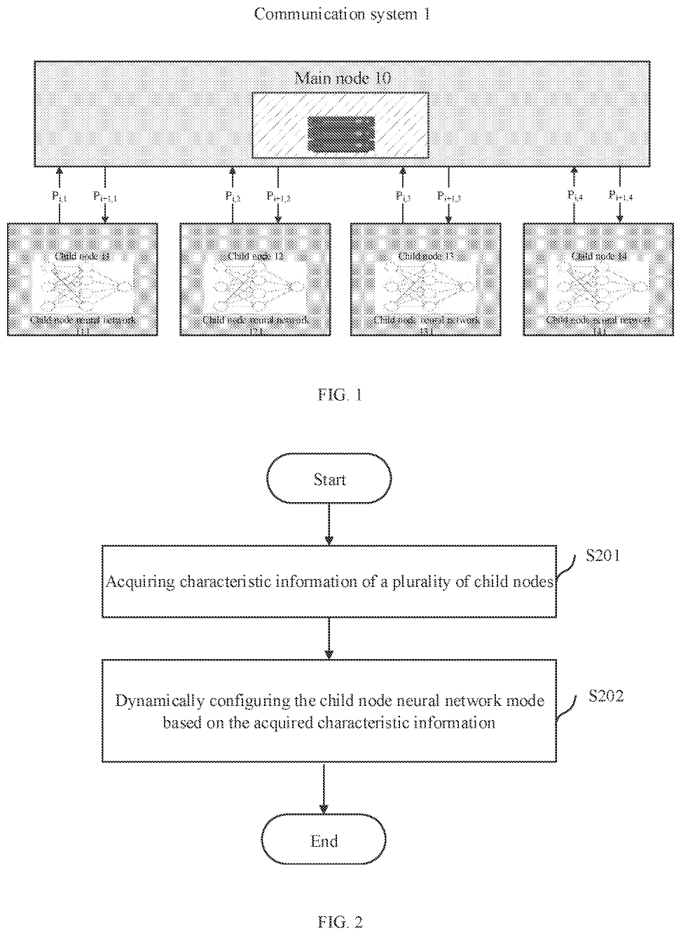

FIG. 2 is a flowchart outlining a communication system configuration method according to an embodiment of the present disclosure. In the communication system 1 as shown in FIG. 1, the communication system configuration method according to the embodiment of the present disclosure shown in FIG. 2 is executed.

Specifically, in step S201, characteristic information of a plurality of child nodes is acquired.

As will be described in detail below with reference to the drawings, in the embodiment of the present disclosure, the characteristic information of a plurality of child nodes may be the height of the child nodes, antenna configuration, coverage area size, service type, traffic volume, user distribution, environmental information, etc. In addition, in the embodiment of the present disclosure, the characteristic information of the plurality of child nodes may also include the historical information acquired by the child node neural network of the plurality of child nodes in the process of performing a specific task. In an embodiment of the present disclosure, the characteristic information of a plurality of child nodes may be that the child nodes report to the master node, or the master node predicts the related characteristic information of the child nodes according to the obtained initial information of the child nodes.

In step S202, the child node neural network model is dynamically configured based on the acquired characteristic information.

As will be described in detail below with reference to the drawings, in the embodiment of the present disclosure, dynamically configuring the child node neural network model may be initializing the configuration of child node neural network model of a new child node when the new child node joins the communication network. In the embodiment of the present disclosure, dynamically configuring the child node neural network model may also be training and updating the child node neural network model of each child node by using online data generated in real time as training data during the operating process of the communication network.

Hereinafter, the specific examples of communication systems and configuration methods therefor according to embodiments of the present disclosure will be described in detail with reference to FIGS. 3 to 11.

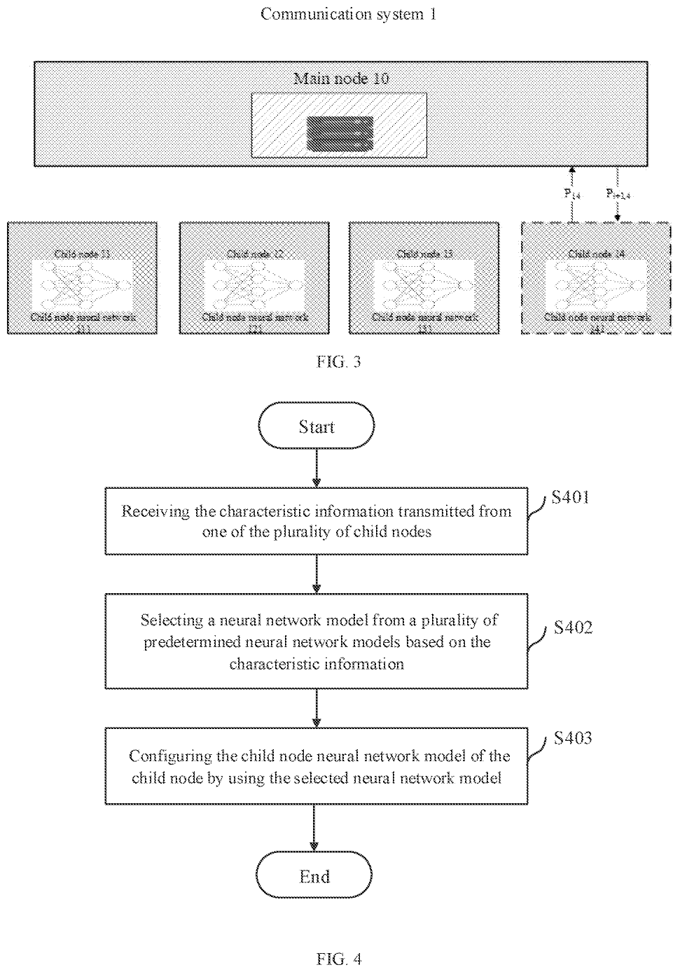

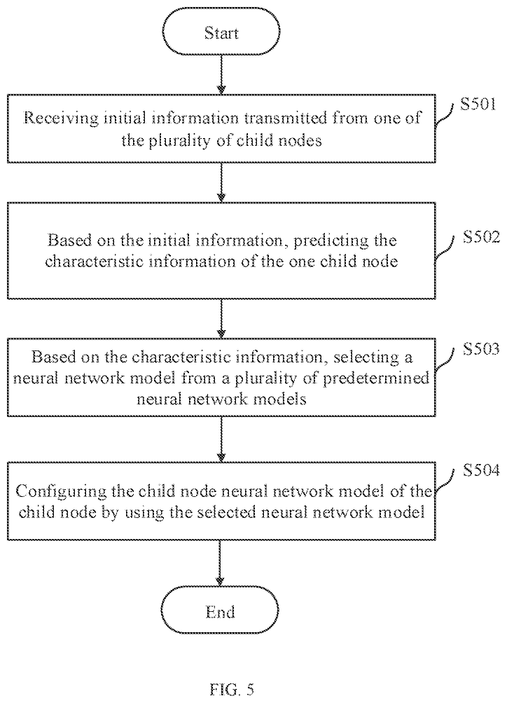

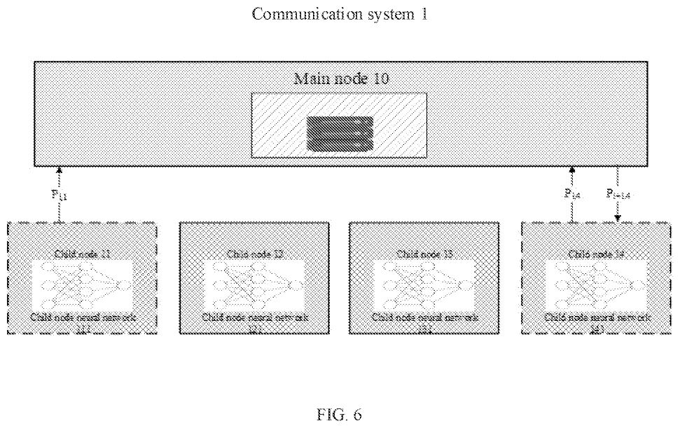

FIG. 3 is a schematic diagram illustrating one configuration example of a communication system according to an embodiment of the present disclosure. As shown in FIG. 3, a child node 14 is newly added to the communication system 1, and the master node 10 initializes the newly added child node 14. FIGS. 4 and 5 are example flowcharts of a communication system configuration method corresponding to the scenario of FIG. 3, and FIG. 4 and FIG. 5 respectively show two different ways of acquiring characteristic information.

As shown in FIG. 4, an example of a communication system configuration method according to an embodiment of the present disclosure includes the following steps.

In step S401, the characteristic information transmitted from one of the plurality of child nodes is received. That is, referring to FIG. 3, the master node 10 receives the characteristic information P_{i,4} transmitted from the newly joined child node 14, and the characteristic information P_{i,4} may be the height, antenna configuration, coverage area size, service type, traffic volume, user distribution, environment information, etc. of the child node 14.

In step S402, based on the characteristic information, a neural network model is selected from a plurality of predetermined neural network models. The master node 10 is provided with a plurality of neural network models in advance, which are used for different child node types and task types. The master node 10 selects one neural network model from a plurality of predetermined neural network models according to the characteristic information P_{i,4} transmitted from the newly added child node 14.

In step S403, the selected neural network model is used to configure the child node neural network model of the child node. The mast node 10 sends a neural network model selected from a plurality of predetermined neural network models to that child nodes 14 through signaling information P_{i+1,4}, thereby configuring the child node neural network model 114 of the one child node 14.

In the embodiments of the present disclosure, the master node can represent the neural network model in many different ways. For example, an index of a plurality of neural network models can be established, and the child node neural network model can be indicated as one of the neural network models by the index. The model weight of the neural network model can be used to indicate the child node neural network model. The model weight variation of the neural network model can be used to indicate the child node neural network model. In addition, the semantic representation of the neural network model can also be used to indicate the child node neural network model, for example, the topological structure diagram of the neural network is used as the semantic representation of the neural network model. It is easy to understand that the expression of the above neural network model is only schematic, and the expression of the neural network model in the communication system configuration method according to the embodiment of the present disclosure is not limited to this.

As shown in FIG. 5, an example of a communication system configuration method according to an embodiment of the present disclosure includes the following steps.

In step S501, initial information transmitted from one of the plurality of child nodes is received. That is, referring to FIG. 3, the master node 10 receives the initial information P_{i,4} transmitted from the newly joined child node 14, and it should be noted that the initial information transmitted by the child node 14 may be different from the characteristic information described with reference to FIG. 4. In addition, in the embodiment of the present disclosure, step S501 is optional, and the newly added child node 14 does not need to report the initial information.

In step S502, based on the initial information, the characteristic information of the one child node is predicted. Unlike the example described with reference to FIG. 4, in the flowchart shown in FIG. 5, the characteristic information of the newly added child nodes 14 is predicted by the master node 10.

In step S503, based on the characteristic information, a neural network model is selected from a plurality of predetermined neural network models. The master node 10 is provided with a plurality of neural network models in advance, which are used for different child node types and task types. The master node 10 selects one neural network model from a plurality of predetermined neural network models according to the predicted characteristic information of newly added child nodes 14.

In step S504, the selected neural network model is used to configure the child node neural network model of the child node. Like the configuration step described with reference to FIG. 4, the master node 10 selects one neural network model from a plurality of predetermined neural network models and sends it to the child nodes 14 through signaling information P_{i+1,4}, thereby configuring the child node neural network model 114 of the one child node 14.

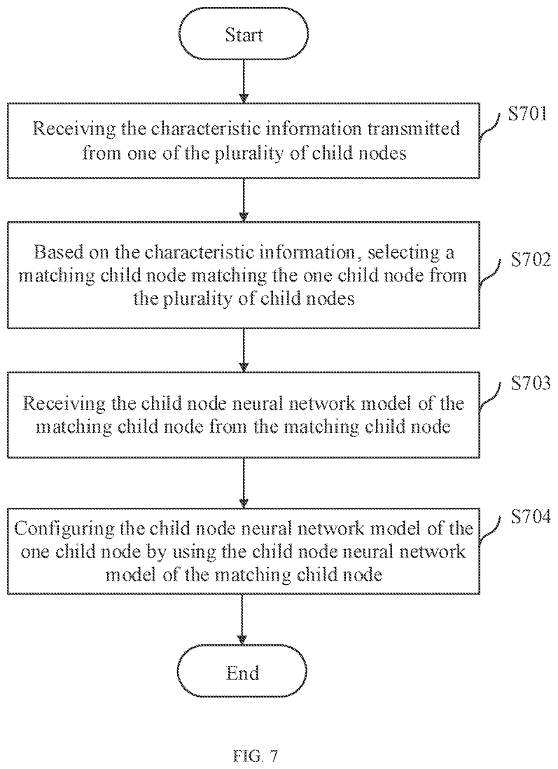

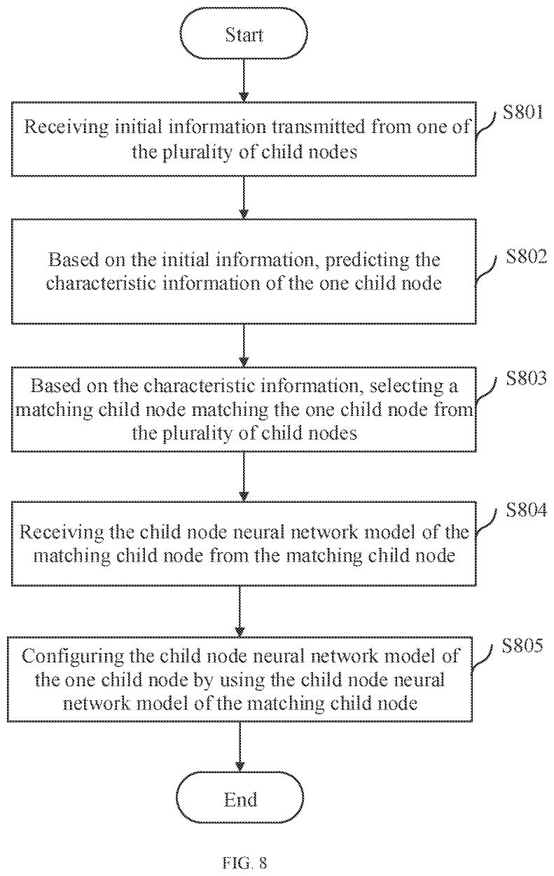

FIG. 6 is a schematic diagram illustrating one configuration example of a communication system according to an embodiment of the present disclosure. Similar to the example shown in FIG. 3, a child node 14 is newly added to the communication system 1, and the master node 10 initializes the newly added child node 14. Unlike the example shown in FIG. 3, in the configuration example shown in FIG. 6, the master node will select the neural network model from the child nodes that are similar to the newly added child nodes, instead of selecting from the predetermined neural network models. FIGS. 7 and 8 are example flowcharts of a communication system configuration method corresponding to the scenario of FIG. 6, and FIGS. 7 and 8 respectively show two different ways of acquiring characteristic information.

As shown in FIG. 7, an example of a communication system configuration method according to an embodiment of the present disclosure includes the following steps.

In step S701, the characteristic information transmitted from one of the plurality of child nodes is received. That is, referring to FIG. 6, the master node 10 receives the characteristic information P_{i,4} transmitted from the newly joined child node 14, and the characteristic information P_{i,4} may be the height, antenna configuration, coverage area size, service type, traffic volume, user distribution, environment information, etc. of the child node 14.

In step S702, based on the characteristic information, a matching child node matching the one child node is selected from the plurality of child nodes. That is, referring to FIG. 6, the master node 10 selects the matching child node 11 that matches the newly added child node 14 from the existing plurality of child nodes based on the characteristic information P_{i,4} transmitted from the newly added child node 14.

In step S703, the child node neural network model of the matching child node is received from the matching child node. That is, referring to FIG. 6, the master node 10 receives the child node neural network model 111 transmitted by the signaling P_{i,1} from the matching child node 11.

In step S704, the child node neural network model of the one child node is configured by using the child node neural network model of the matching child node. That is, as shown in FIG. 6, the master node 10 sends the child node neural network model 111 transmitted by the signaling P_{i,1} from the matching child node 11 to the child node 14 through the signaling information P_{i+1,4}, thereby configuring the child node neural network model 114 of the one child node 14.

As shown in FIG. 8, an example of a communication system configuration method according to an embodiment of the present disclosure includes the following steps.

In step S801, initial information transmitted from one of the plurality of child nodes is received. That is, referring to FIG. 6, the master node 10 receives the initial information P_{i,4} transmitted from the newly joined child node 14, and it should be noted that the initial information transmitted by the child node 14 may be different from the characteristic information described with reference to FIG. 7. In addition, in the embodiment of the present disclosure, step S801 is optional, and the newly added child node 14 does not need to report the initial information.

In step S802, based on the initial information, the characteristic information of the one child node is predicted. Unlike the example described with reference to FIG. 7, in the flowchart shown in FIG. 8, the characteristic information of newly added child nodes 14 is predicted by the master node 10.

In step S803, based on the characteristic information, a matching child node matching the one child node is selected from the plurality of child nodes. That is, referring to FIG. 6, the master node 10 selects the matching child node 11 that matches the newly added child node 14 from the existing plurality of child nodes based on the characteristic information P_{i,4} transmitted from the newly added child node 14.

In step S804, the child node neural network model of the matching child node is received from the matching child node. That is, referring to FIG. 6, the master node 10 receives the child node neural network model 111 transmitted by the signaling P_{i,1} from the matching child node 11.

In step S805, the child node neural network model of the one child node is configured by using the child node neural network model of the matching child node. That is, as shown in FIG. 6, the master node 10 sends the child node neural network model 111 transmitted by the signaling P_{i,1} from the matching child node 11 to the child node 14 through the signaling information P_{i+1,4}, thereby configuring the child node neural network model 114 of the one child node 14.

Above, referring to FIGS. 3 to 8, it has been described that when there is newly added child node in the communication system, the newly added child node is not initially configured by using predetermined default settings, but a targeted optimized configuration is performed according to its own characteristics.

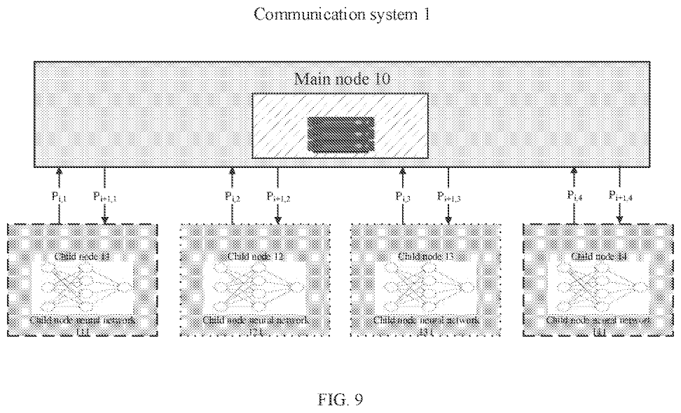

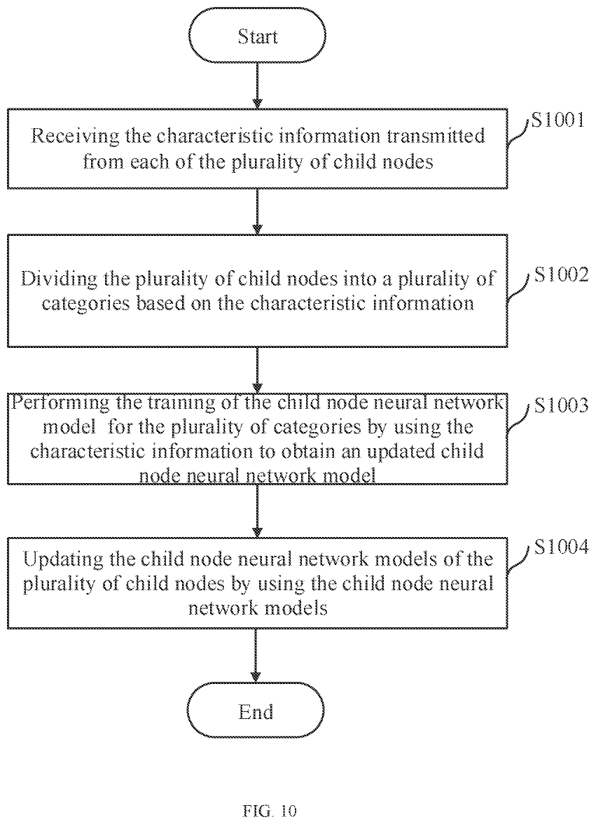

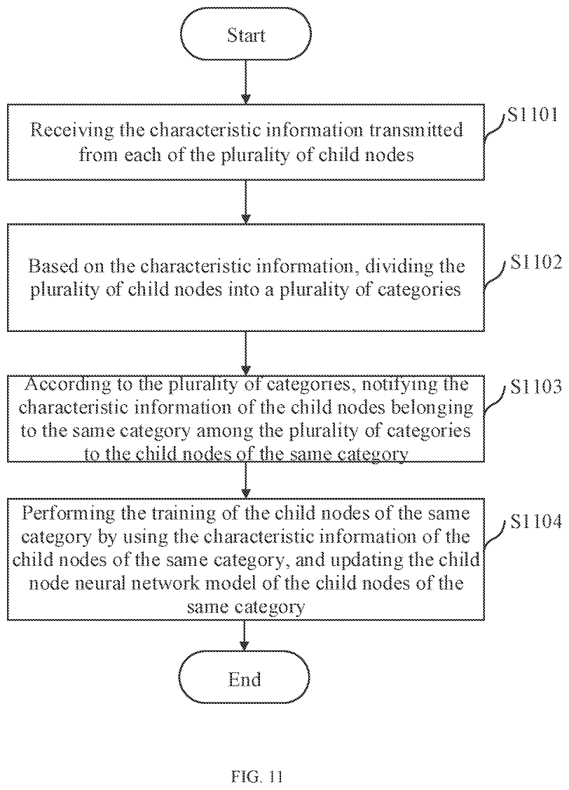

FIG. 9 is a schematic diagram illustrating one configuration example of a communication system according to an embodiment of the present disclosure. As shown in FIG. 9, the master node 10 in the communication system 1 coordinates the training update for each child node 11, 12, 13 and 14. FIGS. 10 and 11 are example flowcharts of a communication system configuration method corresponding to the scenario of FIG. 9, and FIGS. 10 and 11 respectively show two different update modes.

As shown in FIG. 10, an example of a communication system configuration method according to an embodiment of the present disclosure includes the following steps.

At step S1001, the characteristic information transmitted from each of the plurality of child nodes is received. That is, referring to FIG. 9, the master node 10 receives the characteristic information P_{i,1}, P_{i,2}, P_{i,3} and P_{i,4} transmitted from the child nodes 11, 12, 13 and 14. More specifically, in the scenario of training update for each child node 11, 12, 13 and 14, the characteristic information P_{i,1}, P_{i,2}, P_{i,3} and P_{i,4} transmitted from each child node 11, 12, 13 and 14 is online data generated by each child node 11, 12, 13 and 14 for a specific task. For example, in the embodiment described further below, the online data is the historical optimal beam set predicted by the child node for the user equipment.

At step S1002, the plurality of child nodes are divided into a plurality of categories based on the characteristic information. That is, as shown in FIG. 9, the master node 10 divides a plurality of child nodes into two categories, that is, child nodes 11 and 14 belong to one category and child nodes 12 and 13 belong to one category, based on the characteristic information P_{i,1}, P_{i,2}, P_{i,3} and P_{i,4} transmitted from each child node 11, 12, 13 and 14.

At step S1003, the training of the child node neural network model is performed for the multiple categories by using the characteristic information to obtain an updated child node neural network model. That is, as shown in FIG. 9, the master node 10 uses the characteristic information P_{i,1} and P_{i,4} of the first type of child nodes to train the child node neural network models 111 and 141 of the first type of child nodes, and the master node 10 uses the characteristic information P_{i,2} and P_{i,3} of the second type of child nodes to train the child node neural network models 121 and 131 of the second type of child nodes. That is, by training each child node 11, 12, 13, and 14 according to the classification, the available training data is expanded compared with the training process for a single child node, thereby improving the training efficiency and the accuracy of the trained child node neural network model.

At step S1004, the child node neural network models of the plurality of child nodes are updated by using the child node neural network models. That is to say, as shown in FIG. 9, the master node 10 sends the child node neural network models of a plurality of child nodes obtained via training by category to the child nodes 11, 12, 13 and 14 through signaling information P_{i+1,1}, P_{i+1,2}, P_{i+1,3} and P_{i+1,4}, respectively, thereby configuring the child nodes 11, 12, 13 and 14.

As shown in FIG. 11, an example of a communication system configuration method according to an embodiment of the present disclosure includes the following steps.

At step S1101, the characteristic information transmitted from each of the plurality of child nodes is received. That is, referring to FIG. 9, the master node 10 receives the characteristic information P_{i,1}, P_{i,2}, P_{i,3} and P_{i,4} transmitted from the child nodes 11, 12, 13 and 14. More specifically, in the scenario of training update for each child node 11, 12, 13 and 14, the characteristic information P_{i,1}, P_{i,2}, P_{i,3} and P_{i,4} transmitted from each child node 11, 12, 13 and 14 is online data generated by each child node 11, 12, 13 and 14 for a specific task. For example, in the embodiment described further below, the online data is the historical optimal beam set predicted by the child node for the user equipment.

At step S1102, based on the characteristic information, the plurality of child nodes are divided into a plurality of categories. That is, as shown in FIG. 9, the master node 10 divides a plurality of child nodes into two categories, that is, child nodes 11 and 14 belong to one category and child nodes 12 and 13 belong to one category, based on the characteristic information P_{i,1}, P_{i,2}, P_{i,3} and P_{i,4} transmitted from each child node 11, 12, 13 and 14.

At step S1103, according to multiple categories, the characteristic information of the child nodes belonging to the same category among multiple categories is notified to the child nodes of the same category. Unlike the training performed by the master node 10 shown in FIG. 10, in the configuration method shown in FIG. 11, the master node 10 notifies the child nodes of the same category of the characteristic information belonging to the child nodes of the same category in a plurality of categories according to a plurality of categories (two categories as shown in FIG. 9, child nodes 11 and 14 belong to one category, and child nodes 12 and 13 belong to one category). For example, the master node 10 informs the first type of child nodes 11 and 14 of the first type of characteristic information (i.e., the first type of online data) P_{i,1} and P_{i,4} through the signaling P_{i+1,1} and P_{i+1,4}, respectively, and the master node 10 informs the second type of child nodes 12 and 13 of the second type of characteristic information (i.e., the second type of online data) P_{i,2} and P_{i,2} through the signaling P_{i+1,2} and P_{i+1,3}, respectively.

At step S1104, the child nodes of the same category perform training by using the characteristic information of the child nodes of the same category, and update the child node neural network model of the child nodes of the same category. That is, as shown in FIG. 9, child nodes 11 and 14 perform training and update their own child node neural network models 111 and 141 using the first type of characteristic information P_{i,1} and P_{i,4}, and child nodes 12 and 13 perform training and update their own child node neural network models 121 and 131 using the second type of characteristic information P_{i,2} and P_{i,3}. That is to say, each child node 11, 12, 13, and 14 uses the characteristic information of its own category for training, which expands the available training data compared with the training process in which a single child node only uses its own characteristic information, thus improving the training efficiency and the accuracy of the neural network model of the child node obtained by training.

Above, referring to FIGS. 9 to 11, it is described that when the neural network model of each child node is trained and updated in the communication system, instead of using only its own training data for a single child node, child nodes are classified according to their own characteristics, so that all the training data of the same category of child nodes are used to perform the neural network model training and update for this type of child nodes, and the available training data is expanded, thus improving the training efficiency and the accuracy of the obtained child node neural network model.

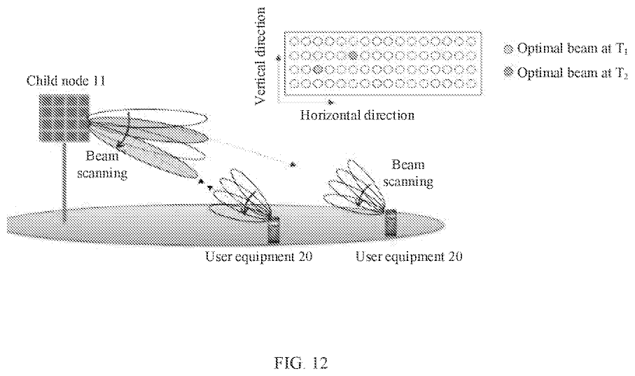

Hereinafter, with further reference to FIGS. 12 to 14, a specific example of training a neural network model of a child node for the purpose of providing an optimal beam candidate set for a user equipment will be described.

FIG. 12 is a schematic diagram illustrating that the communication system according to the embodiment of the present disclosure performs an optimal beam scanning task.

As shown in FIG. 12, the child node 11 is, for example, a base station adopting NR large-scale MIMO. When the user equipment 20 is in a mobile state, the optimal beams of the user equipment 20 at different times T₁ and T₂ will change significantly.

In the communication system according to the embodiment of the present disclosure, the prediction task of the future optimal beam candidate set can be performed on the user equipment 20 through the neural network model 111 configured in the child node 11. It should be understood that in order to perform the prediction task of the future optimal beam candidate set, the neural network model 111 configured in the child node 11 needs to be trained. The training can be performed by the master node 10 or the child node 11 by adopting the communication system configuration method according to the embodiment of the present disclosure described above with reference to FIGS. 3 to 11.

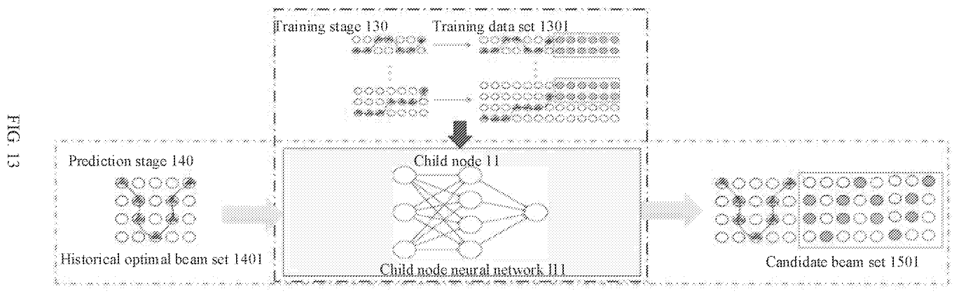

FIG. 13 is a schematic diagram illustrating a training and prediction process of a neural network model configured in a communication system according to an embodiment of the present disclosure.

FIG. 13 shows the training stage 130 and the prediction stage 140 of the neural network model, respectively. In the training stage 130, the historical optimal beam set is used as the training data set 1301. More specifically, in the embodiment of the present disclosure, the relative index of the historical optimal beam is adopted as the training data.

For example, in one embodiment, the difference sequence {{Idxₜ₁−Idxₜₙ}, {Idxₜ₂−idxₜₙ}, {Idxₜₙ₋₁−Idxₜₙ}, {Idxₜₙ₋₁−Idxₜₙ}, and {0} between a plurality of optimal beams Idxₜ₁, Idxₜ₂, . . . Idxtₙ₋₁ at successive time points with an optimal beam Idxₜₙ at a latest time point is adopted as the historical optimal beam set.

In another embodiment, the difference sequence {{0}, {Idxₜ₂−Idxₜ₁}, {Idxₜ₃−Idxₜ₂}, {Idxₜ₄−Idxₜ₃}, {Idxₜₙ−Idxₜₙ₋₁} between the optimal beams of two consecutive time points among successive time points is adopted as the historical optimal beam set.

By configuring the representation of training data in this way, the same changing trend of the optimal beam will be recognized as the same training data by the neural network model, thus reducing the redundancy of training data.

Furthermore, in the embodiment of the present disclosure, the weighted binary cross entropy is used to construct the loss function required for training. In one example, the loss function required for training is expressed as:

Lₙ=−wₙ[yₙ·log(xₙ)+(1−yₙ)·log(1−xₙ)],

xₙ is the prediction result of the neural network model during training, yₙ is the prediction target of the neural network model, and wₙ is the corresponding weight of the corresponding beam. During the initial training, each beam is assigned with the same initial weight. As the training progresses, once a beam becomes the optimal beam, the corresponding weight is increased, and the normalization of all beam weights is maintained. In this way, a more accurate training result can be achieved by using the loss function constructed by considering the frequencies of different beams becoming optimal beams.

In the prediction stage 140, using the historical optimal beam set 1401 as input, the trained child node neural network model 111 of the child node 11 will output the corresponding candidate beam set 1501.

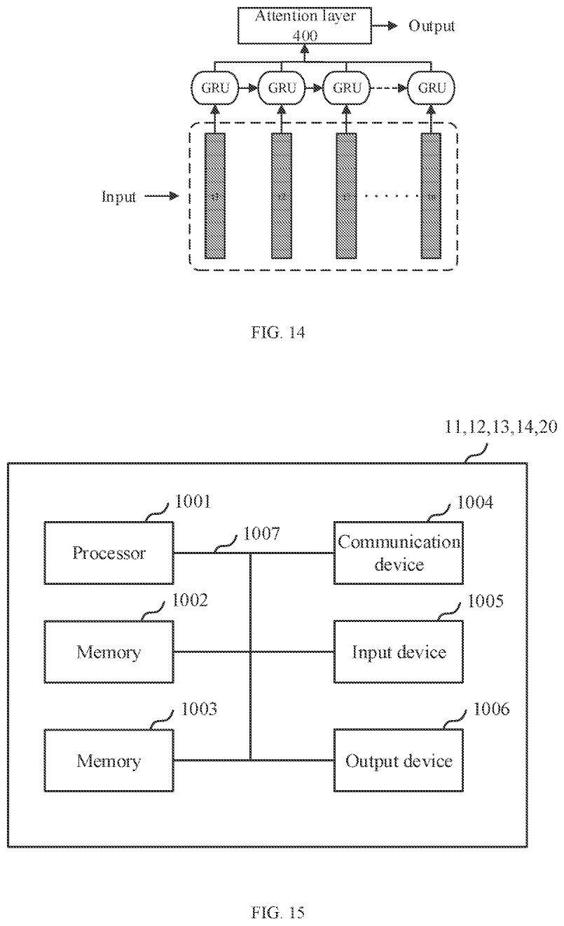

FIG. 14 is a schematic diagram illustrating a neural network model configured in a communication system according to an embodiment of the present disclosure.

As shown in FIG. 14, in one embodiment of the present disclosure, the child node neural network model 111 of the child node 11 uses cascaded gated cyclic unit (GRU) modules to extract the long-term variation trend of the beam. In addition, as shown in FIG. 14, the attention layer 400 is introduced into the neural network model to extract valuable information from the input sequence more effectively, thus effectively improving the accuracy of the optimal beam candidate set prediction, especially in the case of long-term prediction.

FIG. 15 is a block diagram illustrating an example of hardware configuration of a child node and a user equipment according to an embodiment of the present invention. The above-mentioned child nodes 11, 12, 13, 14 and the user equipment 20 can be configured as computer devices that physically include a processor 1001, a memory 1002, a memory 1003, a communication device 1004, an input device 1005, an output device 1006, a bus 1007, and the like.

In addition, in the following description, the words “device” can be replaced by circuit, apparatus, unit, etc. The hardware structure of the child nodes 11, 12, 13, 14 and the user equipment 20 may include one or more devices shown in the figure, or may not include some devices.

For example, only one processor 1001 is shown, but it may be a plurality of processors. In addition, the processing may be performed by one processor, or by more than one processor simultaneously, sequentially, or by other methods. In addition, the processor 1001 can be installed by more than one chip.

The functions of the child nodes 11, 12, 13, 14 and the user equipment 20 are realized, for example, by reading prescribed software (programs) into hardware such as the processor 1001 and the memory 1002, so that the processor 1001 performs operations, controls the communication by the communication device 1004, and controls the reading and/or writing of data in the memory 1002 and the memory 1003.

The processor 1001, for example, makes the operating system work to control the whole computer. The processor 1001 may be composed of a Central Processing Unit (CPU) including interfaces with peripheral devices, control devices, arithmetic devices, registers, etc. In addition, the processor 1001 reads out programs (program codes), software modules, data, etc. from the memory 1003 and/or the communication device 1004 to the memory 1002, and executes various processes according to them. As the program, a program that causes a computer to execute at least part of the actions described in the above embodiment can be adopted. For example, the polarization encoder 300 can be realized by a control program stored in the memory 1002 and operated by the processor 1001, and other functional blocks can be similarly realized. The memory 1002 is a computer-readable recording medium, for example, it can be composed of at least one of a Read Only Memory (ROM), a programmable read only memory (EPROM), an Electrically EPROM programmable read only memory (EEPROM), a Random Access Memory (RAM) and other suitable storage media. The memory 1002 can also be called a register, a cache, a main memory (main storage device), and the like. The memory 1002 can store executable programs (program codes), software modules and the like for implementing the wireless communication method according to an embodiment of the present invention.

The memory 1003 is a computer-readable recording medium, for example, it can be composed of a flexible disk, a floppy disk, a magneto-optical disk (for example, a compact disk, etc.), a digital versatile disk, a Blu-ray (Registered trademark) optical disk, removable disk, hard disk drive, smart card, flash memory device (e.g., card, stick, key driver), magnetic stripe, database, server, and other suitable storage media. The memory 1003 may also be referred to as an auxiliary storage device.

The communication device 1004 is hardware (sending and receiving equipment) used to communicate between computers through wired and/or wireless networks, for example, it is also called network equipment, network controller, network card, communication module, etc. To realize, for example, Frequency Division Duplex (FDD) and/or Time Division Duplex (TDD), the communication device 1004 may include a high-frequency switch, a duplexer, a filter, a frequency synthesizer and the like. For example, the transmitter 202 described above can be implemented by the communication device 1004.

The input device 1005 is an input device (e.g., keyboard, mouse, microphone, switch, button, sensor, etc.) that accepts input from the outside. The output device 1006 is an output device (for example, a display, a speaker, a Light Emitting Diode (LED) lamp, etc.) that outputs to the outside. In addition, the input device 1005 and the output device 1006 may be an integrated structure (for example, a touch panel).

In addition, devices such as the processor 1001 and the memory 1002 are connected by a bus 1007 for communicating information. The bus 1007 can be composed of a single bus or different buses between devices.

In addition, the child nodes 11, 12, 13, 14 and the user equipment 20 may include a microprocessor, a Digital Signal Processor (DSP), an application specific integrated circuit (ASIC), a programmable logic device (PLD, Programmable Logic Device), Field Programmable Gate Array (FPGA) and other hardware, through which part or all of each functional block can be realized. For example, the processor 1001 can be installed by at least one of these hardware.

Above, the communication system based on neural network model and its configuration method according to the present disclosure are described with reference to FIGS. 1 to 15. Dynamic configuration of neural network model of new child nodes in the communication system is realized, and online data is fully utilized in the running process, and centralized update at the master node or distributed update at each child node is realized by the master node. In the process of dynamic configuration and update, the full sharing and utilization of training data and neural network model between the same or similar child nodes is considered, which improves the training efficiency and the accuracy of the obtained model. In addition, in the process of configuration of neural network model, various characteristics of child nodes, such as the height of child nodes, antenna configuration, coverage area size, service type, traffic volume, user distribution, environmental information and historical configuration information, are fully considered, and neural network model is represented by different ways, such as neural network model index, model weight of neural network model, model weight variation of neural network model and semantic representation of neural network model, which further improves the training efficiency and the obtained model. Furthermore, when carrying out the neural network model for specific tasks such as configuring the optimal beam candidate set for the user equipment, by adopting a lightweight recurrent neural network (RNN) and capturing the long-term dependence information of the input sequence by using a gated recurrent unit (GRU) module, selecting an appropriate training data representation and pertinently improving the construction of the loss function, At the same time, attention mechanism is introduced into the neural network model to effectively extract valuable information from the input sequence, thus effectively improving the accuracy of the optimal beam candidate set prediction, especially in the case of long-term prediction.

In addition, the terms described in this specification and/or the terms required for understanding this specification can be interchanged with terms with the same or similar meanings. For example, channels and/or symbols can also be signals (signaling). In addition, the signal can also be a message. The reference signal can also be referred to as RS (ReferenceSignal) for short. According to the applicable standard, it can also be called Pilot, pilot signal, etc. In addition, ComponentCarrier (CC) can also be called cell, frequency carrier, carrier frequency, etc.

In addition, the information, parameters, etc. described in this specification may be expressed by absolute values, relative values to specified values, or other corresponding information. For example, wireless resources can be indicated by a prescribed index. Further, the formulas and the like using these parameters may also be different from those explicitly disclosed in this specification.

The names used for parameters and the like in this specification are not limiting in any way. For example, various channels (PUCCH (PhysicalUplink ControlChannel), PDCCH (PhysicalDownlink ControlChannel), etc.) and information units can be identified by any appropriate names, so the various names assigned to these various channels and information units are not restrictive in any way.

The information, signals, etc. described in this specification can be represented by any of a variety of different technologies. For example, data, commands, instructions, information, signals, bits, symbols, chips, etc. that may be mentioned in all the above descriptions can be represented by voltages, currents, electromagnetic waves, magnetic fields or particles, optical fields or photons, or any combination therefor.

In addition, information, signals, etc. may be output from the upper layer to the lower layer and/or from the lower layer to the upper layer. Information, signals, etc. can be input or output via multiple network nodes.

Or the input and output information, signals, etc. can be stored in a specific place (such as memory) or managed through a management table. Or input information, signals, etc. can be covered, updated or supplemented. The output information, signals, etc. can be deleted. The input information, signals, etc. can be sent to other devices.

The information notification is not limited to the way/embodiment described in this specification, but can also be carried out by other methods. For example, the notification of information can be through physical layer signaling (for example, DownlinkControllnformation (DCI), UplinkControllnformation (UCI)), upper layer signaling (for example, radio resource control (RRC), RadioResourceControl) signaling, broadcast information (MIB (MasterInformationBlock), SIB (SystemInformationBlock), MediumAccessControl (MAC) signaling), other signals or their combination.

In addition, the physical layer signaling can also be called L1/L2 (Layer 1/Layer 2) control information (L1/L2 control signal), L1 control information (L1 control signal), etc. In addition, RRC signaling can also be called RRC message, such as RRC Connection Setup message, RRC Connection Reconfiguration message, etc. In addition, the MAC signaling can be notified by a MAC CE (Control Element), for example.

In addition, the notification of the prescribed information (e.g., notification of ACK and NACK) is not limited to explicit notification, but may be performed implicitly (e.g., by not notifying the prescribed information or by notifying other information).

The determination can be made by a value (0 or 1) represented by 1 bit, a true or false value (Boolean value) represented by true or false, or a comparison of numerical values (for example, with a specified value).

Whether software is called software, firmware, middleware, microcode, hardware description language or other names, it should be broadly interpreted as referring to commands, command sets, codes, code segments, program codes, programs, subroutines, software modules, applications, software applications, software packages, routines, subroutines, objects, executable files, execution threads, steps, functions, etc.

In addition, software, commands, information, etc. can be transmitted or received via a transmission medium. For example, when using wired technology (coaxial cable, optical cable, twisted pair, DSL, etc.) and/or wireless technology (infrared, microwave, etc.) to send software from websites, servers, or other remote resources, these wired technologies and/or wireless technologies are included in the definition of transmission media.

The terms “system” and “network” used in this specification can be used interchangeably.

In this specification, the terms BS, radio Base Station, eNB, gNB, cell, sector, cell group, carrier and component carrier can be used interchangeably. Sometimes, the base station is also called by terms such as fixed station, NodeB eNodeB (eNB), access point, sending point, receiving point, femto cell, small cell, etc.

A base station can accommodate one or more (e.g., three) cells (also called sectors). When a base station accommodates a plurality of cells, the entire coverage area of the base station can be divided into a plurality of smaller areas, and each smaller area can also provide communication services through the base station subsystem (for example, indoor small base station (RRH, Remote Radio Head)). The term “cell” or “sector” refers to a part or the whole of the coverage area of the base station and/or base station subsystem that performs communication services in this coverage.

In this specification, the terms “Mobile Station”, “user terminal”, “User Equipment” and “terminal” can be used interchangeably. Sometimes, the base station is also called by terms such as fixed station, NodeB, eNodeB (eNB), access point, sending point, receiving point, femto cell, small cell, etc.

Mobile stations are sometimes referred to by those skilled in the art as subscriber stations, mobile units, subscriber units, wireless units, remote units, mobile devices, wireless devices, wireless communication devices, remote devices, mobile subscriber stations, access terminals, mobile terminals, wireless terminals, remote terminals, handsets, user agents, mobile clients, clients or some other appropriate terms.

In addition, the wireless base station in this specification can also be replaced by a user terminal. For example, the various modes/embodiments of the present invention can also be applied to the configuration in which the communication between the wireless base station and the user terminal is replaced by the communication between a plurality of user terminals (D2D). At this time, the functions of the above-mentioned child nodes 11, 12, 13, and 14 can be regarded as the functions of the user terminal 20. In addition, words such as “up” and “down” can also be replaced by “side”. For example, the uplink channel can also be replaced by the side channel.

Similarly, the user terminal in this specification can also be replaced by a wireless base station. At this time, the functions of the above-mentioned user terminal 20 can be regarded as the functions of the child nodes 11, 12, 13 and 14.

In this specification, it is assumed that the specific operation performed by the base station may also be performed by its upper node according to the situation. Obviously, in a network composed of one or more network nodes with a base station, various actions for communication with terminals can be performed through the base station, one or more network nodes other than the base station (Mobility Management Entity (MME), Serving-Gateway (S-GW), etc. can be considered, but not limited to this), or

The modes/embodiments described in this specification can be used alone, in combination, or switched during execution. In addition, the processing steps, sequences, flow charts, etc. of each mode/embodiment described in this specification can be changed as long as there is no contradiction. For example, regarding the method described in this specification, various step units are given in an exemplary order, but not limited to the given specific order.

The modes/embodiments described in this specification can be applied to Long Term Evolution (LTE), LTE-A (LTE-Advanced), LTE-B (Beyond Long Term Evolution), LTE-Beyond), SUPER 3G, IMT-Advanced, 4th Generation Mobile Communication System (4G), 5th Generation Mobile Communication System (5G), Future Radio Access (FRA), new Radio Access Technology (New-RAT), New Radio (NR), new radio access (NX), future generation radio access (FX), Global System for Mobile Communications (GSM (registered trademark)), Global system for mobile communications, code division multiple access 2000 (CDMA2000), ultra mobile broadband (UMB, Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), other suitable wireless communication methods, and/or systems based on them.

The record of “according to” used in this specification does not mean “only according to” as long as it is not explicitly stated in other paragraphs. In other words, records like “according to” refer to “only according to” and “at least according to”.

Any reference to units with names such as “first” and “second” used in this specification is not a comprehensive limitation on the number or order of these units. These names can be used in this specification as a convenient way to distinguish more than two units. Therefore, the reference of the first unit and the second unit does not mean that only two units can be used or that the first unit must precede the second unit in some forms.

The term “determining” used in this specification sometimes includes various actions. For example, regarding “determining”, calculating, computing, processing, deriving, investigating, looking up (such as searching in tables, databases, or other data structures), ascertaining, and the like can be used. In addition, regarding “determining”, receiving (e.g., receiving information), transmitting (e.g., sending information), inputting, outputting, accessing (e.g., accessing data in memory), etc. can also be regarded as making “determining”. In addition, regarding “determining”, resolving, selecting, choosing, establishing, comparing, etc. can also be regarded as “determining”. That is to say, regarding “determining”, several actions can be regarded as “determining”.

As used in this specification, terms such as “connected” and “coupled” or any variation therefor refer to any direct or indirect connection or combination between two or more units, which may include the following situations: between two units that are “connected” or “coupled” with each other, there are one or more intermediate units. The combination or connection between units can be physical, logical, or a combination of both. For example, “connect” can also be replaced with “access”. As used in this specification, it can be considered that two units are “connected” or “combined” with each other by using one or more wires, cables, and/or printed electrical connections, and as several non-limiting and non-exhaustive examples, by using electromagnetic energy with the wavelength of radio frequency region, microwave region, and/or light (both visible light and invisible light) region, etc.

When “including”, “comprising” and their variations are used in this specification or claims, these terms are as open as the term “having”. Further, the term “or” used in this specification or claims is not exclusive or.

The present invention has been described in detail above, but it is obvious to those skilled in the art that the present invention is not limited to the embodiments described in this specification. The invention can be implemented as modifications and changes without departing from the spirit and scope of the invention as defined by the claims. Therefore, the description of this specification is for the purpose of illustration, and does not have any restrictive meaning for the present invention.

1. A communication system configuration method based on neural network model, the communication system comprises at least one master node and a plurality of child nodes communicatively connected with the master node, and a child node neural network model is configured in each of the plurality of child nodes, the communication system configuration method comprises:
acquiring characteristic information of the plurality of child nodes; and
dynamically configuring the child node neural network model based on the acquired characteristic information.

2. The communication system configuration method of claim 1, wherein the acquiring characteristic information of the plurality of child nodes comprises:
receiving the characteristic information transmitted from one child node of the plurality of child nodes, or
receiving initial information transmitted from one child node of the plurality of child nodes, and predicting the characteristic information of the one child node based on the initial information.

3. (canceled)

4. The communication system configuration method of claim 2,
wherein the dynamically configuring the child node neural network model based on the acquired characteristic information comprises:
selecting one neural network model from a plurality of predetermined neural network models based on the characteristic information; and
configuring the child node neural network model of the one child node by using the selected one neural network model.

5. The communication system configuration method of claim 2,
wherein the dynamically configuring the child node neural network model based on the acquired characteristic information comprises:
selecting a matching child node that matches the one child node from the plurality of child nodes based on the characteristic information;
receiving a child node neural network model of the matching child node from the matching child node; and
configuring the child node neural network model of the one child node by using the child node neural network model of the matching child node.

6. (canceled)

7. The communication system configuration method of claim 1, wherein the acquiring characteristic information of the plurality of child nodes comprises:
receiving the characteristic information transmitted from each of the plurality of child nodes.

8. The communication system configuration method of claim 7, wherein the dynamically configuring the child node neural network model based on the acquired characteristic information comprises:
dividing the plurality of child nodes into a plurality of categories based on the characteristic information;
using the characteristic information, training the child node neural network model for the plurality of categories to obtain an updated child node neural network model; and
updating the child node neural network models of the plurality of child nodes by using the child node neural network model.

9. The communication system configuration method of claim 7, wherein the dynamically configuring the child node neural network model based on the acquired characteristic information comprises:
dividing the plurality of child nodes into a plurality of categories based on the characteristic information;
notifying the characteristic information of the child nodes belonging to a same category among the plurality of categories to the child nodes of the same category according to the plurality of categories; and
training the child nodes of the same category by using the characteristic information of the child nodes of the same category, and updating the child node neural network model of the child nodes of the same category.

10. (canceled)

11. The communication system configuration method of claim 1, wherein the configuring the child node neural network model comprises one of:
establishing indexes of a plurality of neural network models, and using the indexes to indicate that the child node neural network model is one of the neural network models;
indicating the child node neural network model by using a model weight of the neural network model;
indicating the child node neural network model by using a model weight variation of the neural network model; and
indicating the child node neural network model by using a semantic representation of the neural network model.

12. The communication system configuration method of claim 7, wherein the characteristic information is a historical optimal beam set of a user equipment corresponding to the child node, and
wherein the historical optimal beam set comprises a difference sequence between a plurality of optimal beams at a plurality of consecutive time points and an optimal beam at a latest time point; or
a difference sequence between the optimal beams of two adjacent time points in a plurality of consecutive time points.

13. The communication system configuration method of claim 12, wherein updating the child node neural network model by using the characteristic information comprises:
determining a weight of each historical optimal beam by using the occurrence times of each historical optimal beam in the historical optimal beam set; and
according to the weight of each historical optimal beam and the historical optimal beam set, constructing a weighted loss function to perform training to update the child node neural network model.

14. (canceled)

15. A communication system based on a neural network model, comprising:
at least one master node;
a plurality of child nodes, which are communicatively connected with the master node, and a child node neural network model is configured in each of the plurality of child nodes,
wherein the at least one master node acquires the characteristic information of the plurality of child nodes; and
dynamically configuring the child node neural network model based on the acquired characteristic information.

16. The communication system of claim 15, wherein the at least one master node receives the characteristic information transmitted from one child node of the plurality of child nodes, or the at least one master node receives initial information transmitted from one of the plurality of child nodes and predicts the characteristic information of the one child node based on the initial information.

17. (canceled)

18. The communication system of claim 16, wherein the at least one master node selects one neural network model from a plurality of predetermined neural network models based on the characteristic information; and
configuring the child node neural network model of the child node by using the selected one neural network model.

19. The communication system of claim 16, wherein the at least one master node selects a matching child node that matches the one child node from the plurality of child nodes based on the characteristic information;
receives a child node neural network model of the matching child node from the matching child node; and
configures the child node neural network model of the one child node by using the child node neural network model of the matching child node.

20. (canceled)

21. The communication system of claim 15, wherein the at least one master node receives the characteristic information transmitted from each of the plurality of child nodes.

22. The communication system of claim 21, wherein the at least one master node divides the plurality of child nodes into a plurality of categories based on the characteristic information;
using the characteristic information, trains the child node neural network model for the plurality of categories to obtain an updated child node neural network model; and
updates the child node neural network models of the plurality of child nodes by using the child node neural network model.

23. The communication system of claim 21, wherein the at least one master node divides the plurality of child nodes into a plurality of categories based on the characteristic information;
notifies the characteristic information of the child nodes belonging to a same category among the plurality of categories to the child nodes of the same category according to the plurality of categories; and
trains the child nodes of the same category by using the characteristic information of the child nodes of the same category, and updates the child node neural network model of the child nodes of the same category.

24. (canceled)

25. The communication system of claim 15, wherein the configuring the child node neural network model comprises one of:
establishing indexes of a plurality of neural network models, and using the indexes to indicate that the child node neural network model is one of the neural network models;
indicating the child node neural network model by using a model weight of the neural network model;
indicating the child node neural network model by using a model weight variation of the neural network model; and
indicating the child node neural network model by using a semantic representation of the neural network model.

26. The communication system of claim 21, wherein the characteristic information is a historical optimal beam set of a user equipment corresponding to the child node, and
wherein the historical optimal beam set comprises a difference sequence between a plurality of optimal beams at a plurality of consecutive time points and an optimal beam at a latest time point; or
a difference sequence between the optimal beams of two adjacent time points in a plurality of consecutive time points.

27. The communication system of claim 26, wherein the at least one master node or the child node determines a weight of each historical optimal beam by using the occurrence times of each historical optimal beam in the historical optimal beam set; and
according to the weight of each historical optimal beam and the historical optimal beam set, constructs a weighted loss function to perform training to update the child node neural network model.

28. (canceled)
